(19) United States
(12) Patent Application Publication
(10) Pub. No.: US 2019/0329718 A1
(43) Pub. Date: Oct. 31, 2019

(54) ELECTRON MIRROR APPARATUS

(71) Applicant: Panasonic Intellectual Property Management Co., Ltd., Osaka (JP)

(72) Inventor: MASANOBU KANAYA, Kanagawa (JP)

(21) Appl. No.: 16/305,407

(22) PCT Filed: Oct. 18, 2017
(86) PCT No.: PCT/JP2017/037619

§ 371 Date: Nov. 29, 2018

(30) Foreign Application Priority Data
Oct. 26, 2016 (JP) 2016-209927

(51) Int. Cl. B60R 11/04; B60R 1/07; B60R 1/12; B60D 1/36

(52) U.S. Cl. CPC B60R 11/04; B60R 1/07; B60R 2001/1253; B60D 1/36; B60R 1/12

(57) ABSTRACT

A rearview mirror assembly includes: a display for displaying a first image from a first on-vehicle camera that is installed on a hatch of a vehicle and images a rear viewing field of the vehicle; an opened or closed state determination unit for determining whether the hatch is opened or closed; and a display controller for controlling displaying and non-displaying of the first image on the display. When the opened or closed state determination unit determines that the hatch is closed, the display controller causes the display to display the first image. When the opened or closed state determination unit determines that the hatch is opened, the display controller causes the display not to display the first image.

### TECHNICAL FIELD

The present invention relates to an electronic mirror apparatus that displays an image captured by an on-vehicle camera installed on a hatch.

### BACKGROUND ART

An electronic mirror apparatus in which an on-vehicle camera and a display are combined is recently put into practical use, and expected as a substitute for a rearview mirror (including a vehicle interior rearview mirror such as a windshield rearview mirror and a vehicle exterior rearview mirror such as a side mirror (door mirror)). In the electronic mirror apparatus, surroundings of the vehicle are imaged by the on-vehicle camera, and a captured image is displayed on the display.

For example, PTL 1 discloses an electronic mirror apparatus (on-vehicle display apparatus) including a half mirror for imaging a rear viewing field of a vehicle, a rear camera installed in a rear part of the vehicle, and a display for displaying an image captured by the rear camera. This electronic mirror apparatus switches display and non-display of the captured image based on an angle of a mirror body. Further, for example, PTL 2 discloses an electronic mirror apparatus including a mirror camera installed near a windshield rearview mirror, a rear camera installed in a rear part of a vehicle, and a display for displaying an image captured by the mirror camera and an image captured by the rear camera by switching the images. This electronic mirror apparatus switches the images to be displayed when target objects (e.g., following vehicles) included in the captured images are equal in size.

### CITATION LIST

### Patent Literature

PTL 1: Japanese Patent No. 5906503

PTL 2: WO 2016/042733

### SUMMARY OF THE INVENTION

The present invention is an electronic mirror apparatus that displays an image captured by an on-vehicle camera installed on a hatch, and provides an electronic mirror apparatus capable of preventing meaningless information to an occupant from being presented.

An electronic mirror apparatus according to the present invention includes: a display for displaying a first image from a first on-vehicle camera that is installed on a hatch of a vehicle and images a rear viewing field of the vehicle; an opened or closed state determination unit for determining whether the hatch is opened or closed; and a display controller for controlling displaying and non-displaying of the first image on the display. When the opened or closed state determination unit determines that the hatch is closed, the display controller causes the display to display the first image. When the opened or closed state determination unit determines that the hatch is opened, the display controller causes the display not to display the first image.

According to the present invention, it is possible to prevent information meaningless to an occupant from being presented on an electronic mirror apparatus that displays an image captured by an on-vehicle camera installed on a hatch.

### BRIEF DESCRIPTION OF DRAWINGS

FIG. 1A is a view illustrating an installation mode of an electronic mirror apparatus according to a first exemplary embodiment.

FIG. 1B is a view illustrating an installation mode of the electronic mirror apparatus according to the first exemplary embodiment.

FIG. 2 is a diagram illustrating a configuration of the electronic mirror apparatus according to the first exemplary embodiment.

FIG. 3 is a flowchart illustrating an example of display processing in the first exemplary embodiment.

FIG. 4A is a view illustrating a display example in the display processing in the first exemplary embodiment.

FIG. 4B is a view illustrating a display example in the display processing in the first exemplary embodiment.

FIG. 5A is a view illustrating an installation mode of an electronic mirror apparatus according to a second exemplary embodiment.

FIG. 5B is a view illustrating an installation mode of the electronic mirror apparatus according to the second exemplary embodiment.

FIG. 6 is a diagram illustrating a configuration of the electronic mirror apparatus according to the second exemplary embodiment.

FIG. 7 is a flowchart illustrating an example of display processing in the second exemplary embodiment.

FIG. 8A is a view illustrating a display example in the display processing in the second exemplary embodiment.

FIG. 8B is a view illustrating a display example in the display processing in the second exemplary embodiment.

### DESCRIPTION OF EMBODIMENTS

Before exemplary embodiments of the present invention are described, problems in a conventional technique will be briefly described. Of a hatchback type vehicle including a rear door or a rear window (hereinafter generally referred to as “hatch”) that jumps up, a rear camera may be installed on the hatch. In this case, a rear viewing field is imaged by the rear camera while the vehicle is running. However, when the hatch is opened and loading and unloading of cargo is performed, since the rear camera images an upper viewing field of the vehicle (e.g., sky), an image that is completely meaningless to an occupant is displayed.

Hereinafter, the exemplary embodiments of the present invention will be described in detail with reference to the drawings.

### First Exemplary Embodiment

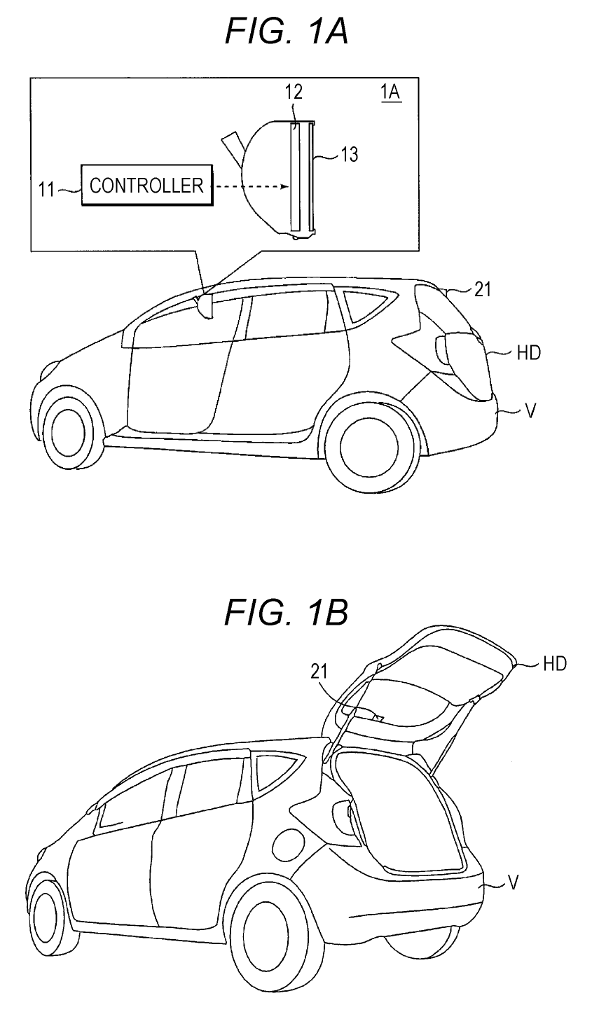

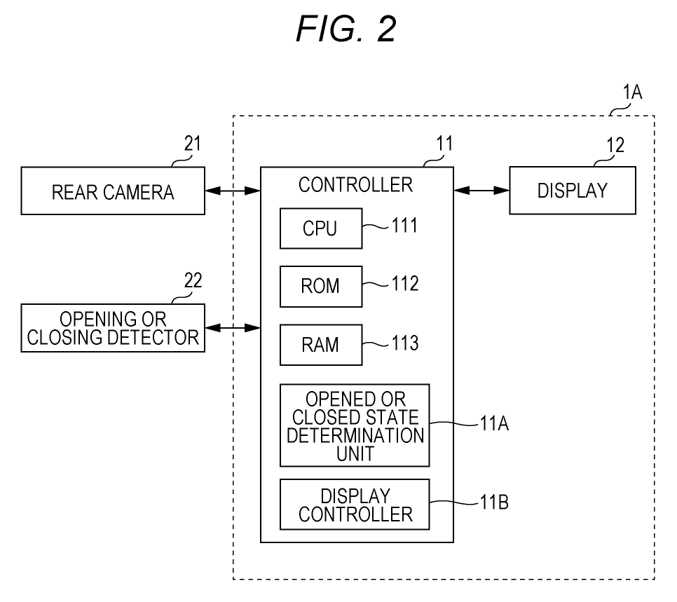

FIGS. 1A and 1B are views each illustrating an installation mode of electronic mirror apparatus 1A according to a first exemplary embodiment. FIG. 2 is a diagram illustrating a configuration of electronic mirror apparatus 1A according to the first exemplary embodiment. For example, electronic mirror apparatus 1A is suspended from a ceiling of a vehicle interior near a windshield of vehicle V and used for rear confirmation.

In electronic mirror apparatus 1A, display 12 displays an image (a moving image) of a rear viewing field captured by rear camera 21 disposed in rear door HD of vehicle V. Vehicle V is a hatchback type vehicle in which rear door HD is jumped up. Rear camera 21 includes an imaging element such as a charge-coupled device (CCD) image sensor or a complementary metal oxide semiconductor (CMOS) image sensor. An electric signal that is photo-electric converted by the imaging element and is indicative of the image of the rear viewing field is sent to electronic mirror apparatus 1A via wireless communication or wired communication.

As illustrated in FIGS. 1A and 2, electronic mirror apparatus 1A includes controller 11, display 12, one-way mirror 13, and the like.

For example, display 12 is a liquid crystal display including a display panel and a backlight (not illustrated). Display 12 is mounted on an upper center (a mounting position of a general windshield rearview mirror) of the windshield in the vehicle interior, for example (see FIG. 1A). The liquid crystal panel has an external shape similar to an external shape of one-way mirror 13 or an outer shape corresponding to a display area. Note that an organic electroluminescence (EL) display may be applied to display 12.

One-way mirror 13 is disposed on a forefront surface (an opening of a housing (a reference mark is omitted)). Display 12 is disposed at a rear surface side of one-way mirror 13 (an interior of the housing). One-way mirror 13 is an optical member that reflects incident light from a front surface side, and transmits incident light from a rear surface side. For example, a half mirror in which reflectance is equal to transmittance can be used as one-way mirror 13.

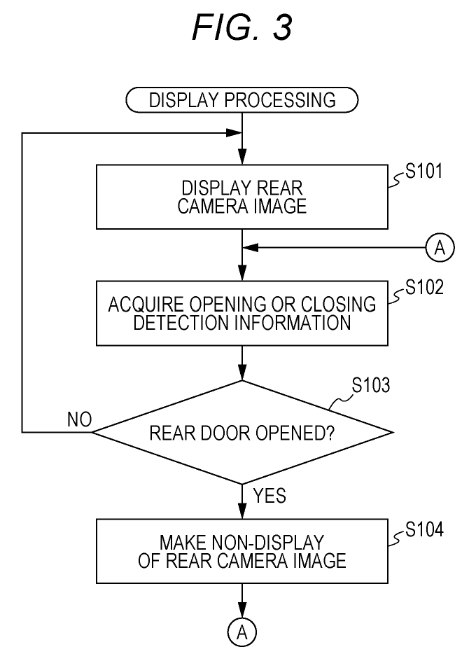

Controller 11 includes central processing unit (CPU) 111, read only memory (ROM) 112, random access memory (RAM) 113, and the like. For example, CPU 111 reads a program according to a processing content from ROM 112, develops the program in RAM 113, and performs centralized control of operation of each block of electronic mirror apparatus 1A in conjunction with the developed program. Controller 11 functions as opened or closed state determination unit 11A and display controller 11B. The functionality is described later in detail with reference to a flowchart in FIG. 3.

Electronic mirror apparatus 1A has a first use mode (display mode) for performing rear visual recognition by a display image of display 12 and a second use mode (a mirror mode) for performing rear visual recognition by a mirror image projected on a mirror surface of one-way mirror 13. In the first use mode, display 12 is in an on state, and a driver visually recognizes the display image of display 12 through one-way mirror 13. On the other hand, in the second use mode, display 12 is in an off state, and the driver visually recognizes the mirror image projected on one-way mirror 13.

The first use mode and the second use mode are switched in conjunction with an operation of a changeover switch (not illustrated), for example. Furthermore, in the present exemplary embodiment, the first use mode (display mode) can be switched to the second use mode (mirror mode) according to an opened or closed state of rear door HD.

At this time, controller 11 determines the opened or closed state of rear door HD (processing is performed by opened or closed state determination unit 11A) based on a detection signal from opening or closing detector 22 that detects an opened or closed state of rear door HD.

For example, a lock detector that detects a locked state of rear door HD can be applied to opening or closing detector 22. In this case, controller 11 as opened or closed state determination unit 11A receives a lock signal indicating the locked state of rear door HD from the lock detector and determines the opened or closed state of rear door HD based on this lock signal. The lock signal from the lock detector can be acquired through an electronic control unit (ECU) (not illustrated) of vehicle V, for example.

Further, for example, an acceleration sensor mounted on rear door HD can be applied to opening or closing detector 22. In this case, controller 11 as opened or closed state determination unit 11A receives an output signal from the acceleration sensor and determines the opened or closed state of rear door HD based on this output signal. The output signal from the acceleration sensor can be acquired through the ECU (not illustrated) of vehicle V, for example.

FIG. 3 is a flowchart illustrating an example of display processing in electronic mirror apparatus 1A. For example, CPU 111 calls a display processing program stored in ROM 112 in response to stopping of vehicle V, and executes the display processing program, thereby performing this processing.

In step S101, controller 11 causes display 12 to display an image captured by rear camera 21 (hereinafter referred to as “rear camera image”) (processing is performed by display controller 11B).

In step S102, controller 11 acquires information indicating the opened or closed state of rear door HD (hereinafter referred to as “opening or closing detection information”) from opening or closing detector 22 (processing is performed by opened or closed state determination unit 11A).

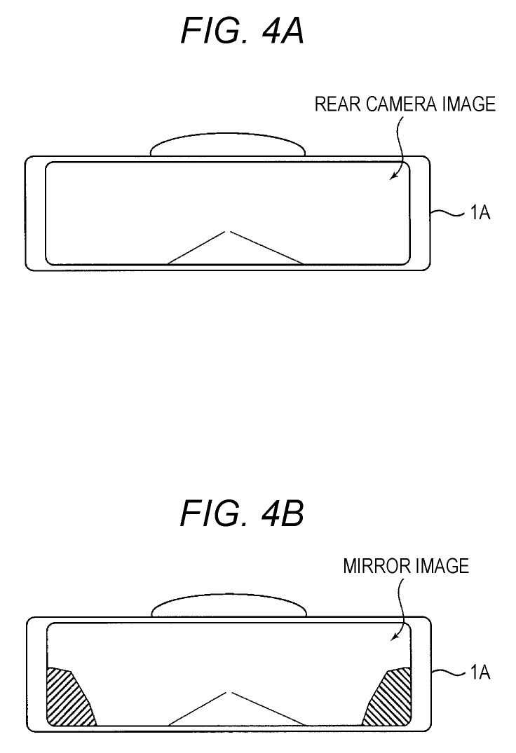

In step S103, controller 11 determines whether rear door HD is opened (processing is performed by opened or closed state determination unit 11A). If rear door HD is opened (“YES” in step S103), the flowchart transfers to processing in step S104. If rear door HD is closed (“NO” in step S103), the flowchart transfers to processing in step S101. In other words, if rear door HD is closed, the rear camera image is continuously displayed on display 12 (see FIG. 4A).

In step S104, controller 11 makes non-display of the rear camera image on display 12 (for example, a backlight is turned off). In other words, if rear door HD is opened, in electronic mirror apparatus 1A, the mode is switched to the mirror mode, and the mirror image in one-way mirror 13 can be visually recognized (see FIG. 4B).

When rear door HD is opened and loading and unloading of cargo is performed, since rear camera 21 images an upper viewing field of the vehicle (e.g., sky), the rear camera image becomes completely meaningless to an occupant. In the first exemplary embodiment, since the rear camera image on display 12 is made non-display and a rear viewing field can be visually recognized by one-way mirror 13 in this case, electronic mirror apparatus 1A can be used effectively.

After the mode is switched to the mirror mode in step S104, the flowchart transfers to step S102. In other words, the mirror mode is continued until rear door HD is closed, and when rear door HD is opened, the flowchart transfers to step S101, and the mode is switched to the display mode. As illustrated in FIGS. 4A and 4B, since a back seat is projected and a part of the rear viewing field of vehicle V is cut off in the mirror image in one-way mirror 13, the rear camera image is more suitable for rear confirmation. Note that the display processing illustrated in FIG. 3 is finished in response to starting of vehicle V.

Thus, electronic mirror apparatus 1A includes; display 12 for displaying an image from rear camera 21 (first on-vehicle camera) that is installed in rear door HD (hatch) of vehicle V and images a rear viewing field of vehicle V; opened or closed state determination unit 11A for determining whether the rear door HD is opened or closed; and display controller 11B for controlling display and non-display of a rear camera image (first image) on display 12. When opened or closed state determination unit 11A determines that rear door HD is closed, display controller 11B causes display 12 to display the rear camera image. On the other hand, when opened or closed state determination unit 11A determines that rear door HD is opened, display controller 11B makes non-display of the rear camera image.

Specifically, electronic mirror apparatus 1A includes one-way mirror 13 disposed at a display surface side of display 12. In electronic mirror apparatus 1A, when opened or closed state determination unit 11A determines that rear door HD is closed, the rear camera image (first image) on display 12 is visually recognized, and when opened or closed state determination unit 11A determines that rear door HD is opened, the mirror image in one-way mirror 13 is visually recognized.

According to electronic mirror apparatus 1A, it is possible to prevent information meaningless to an occupant (for example, a rear camera image on which sky is projected) from being presented and is possible to present useful information to the occupant (herein, the mirror image in one-way mirror 13).

### Second Exemplary Embodiment

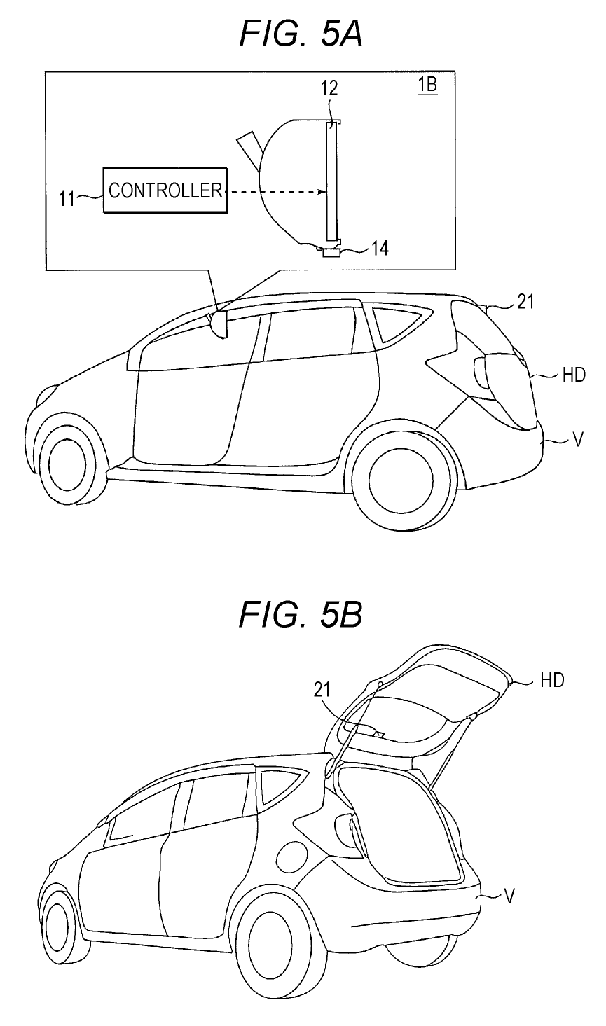

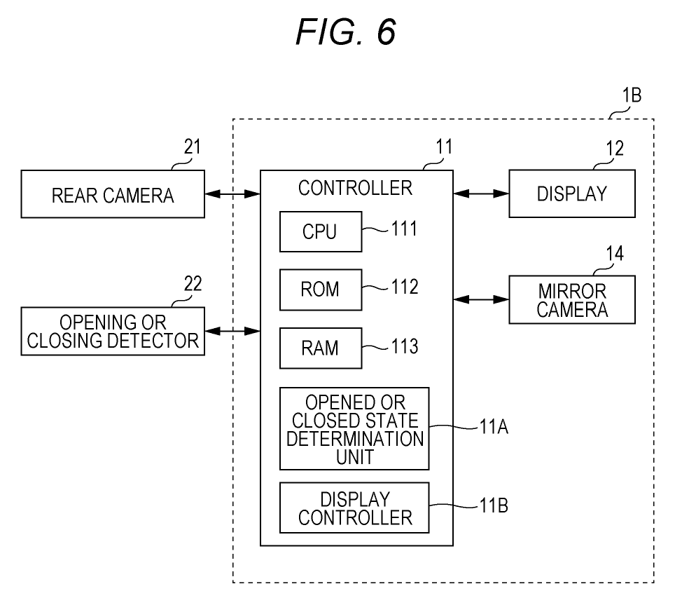

FIGS. 5A and 5B are views each illustrating an installation mode of electronic mirror apparatus 1B according to a second exemplary embodiment. FIG. 6 is a diagram illustrating a configuration of electronic mirror apparatus 1B according to the second exemplary embodiment. Compared with electronic mirror apparatus 1A according to the first exemplary embodiment, electronic mirror apparatus 1B is different in that electronic mirror apparatus 1B includes mirror camera 14 and does not include one-way mirror 13. In electronic mirror apparatus 1B, when it is determined that rear door HD is opened, an image captured by mirror camera 14 installed in a part other than rear door HD is displayed on display 12. Among components of electronic mirror apparatus 1B according to the second exemplary embodiment, identical reference marks are assigned to components that are identical or corresponding to those in electronic mirror apparatus 1A according to the first exemplary embodiment, and descriptions thereof are omitted.

In electronic mirror apparatus 1B, display 12 selectively displays an image (a moving image) of a rear viewing field imaged by rear camera 21 disposed in rear door HD of vehicle V or an image of a rear viewing field imaged by mirror camera 14. In a normal state (a state in which rear door HD is closed), the image captured by rear camera 21 is displayed in electronic mirror apparatus 1B. A configuration of mirror camera 14 is similar to that of rear camera 21. Mirror camera 14 is installed near display 12, for example, at a lower part of a housing of electronic mirror apparatus 1B (see FIG. 5A).

In electronic mirror apparatus 1B, rear visual recognition is performed by a display image of display 12. In other words, electronic mirror apparatus 1B does not have a first use mode (display mode) and a second use mode (mirror mode) like electronic mirror apparatus 1A according to the first exemplary embodiment. Note that electronic mirror apparatus 1B may include one-way mirror 13 in the first exemplary embodiment and switch the first use mode and the second use mode.

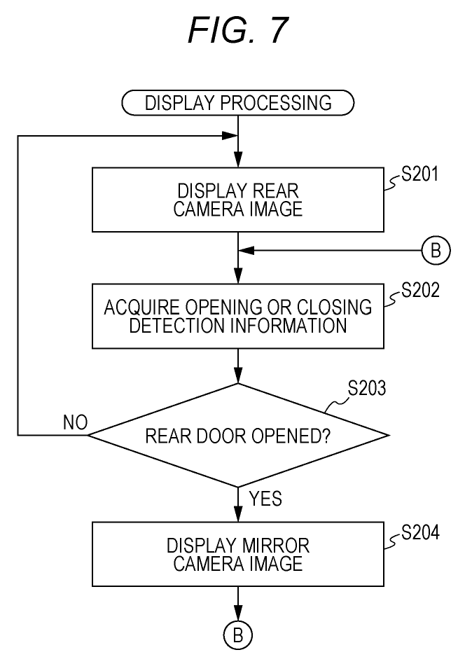

FIG. 7 is a flowchart illustrating an example of display processing in electronic mirror apparatus 1B. For example, CPU 111 calls a display processing program stored in ROM 112 in response to stopping of vehicle V, and executes the display processing program, thereby performing this processing.

In step S201, controller 11 causes display 12 to display an image captured by rear camera 21 (hereinafter referred to as “rear camera image”) (processing is performed by display controller 11B).

In step S202, controller 11 acquires information indicating an opened or closed state of rear door HD (hereinafter referred to as “opening or closing detection information”) from opening or closing detector 22 (processing is performed by opened or closed state determination unit 11A).

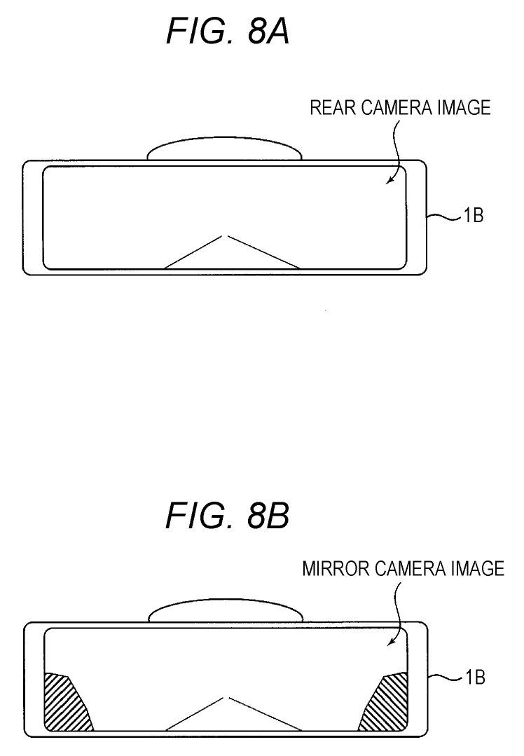

In step S203, controller 11 determines whether rear door HD is opened (processing is performed by opened or closed state determination unit 11A). If rear door HD is opened (“YES” in step S203), the flowchart transfers to processing in step S204. If rear door HD is closed (“NO” in step S203), the flowchart transfers to processing in step S201. In other words, if rear door HD is closed, the rear camera image is continuously displayed on display 12 (see FIG. 8A).

In step S204, controller 11 switches the rear camera image on display 12 to an image captured by mirror camera 14 (hereinafter “mirror camera image”). In other words, in electronic mirror apparatus 1B, if rear door HD is opened, the mirror camera image obtained by imaging a rear viewing field of vehicle V regardless of an opened or closed state of rear door HD can be visually recognized (see FIG. 8B).

When rear door HD is opened and loading and unloading of cargo is performed, since rear camera 21 images an upper viewing field of the vehicle (e.g., sky), the rear camera image becomes completely meaningless to an occupant. In the second exemplary embodiment, since display on display 12 is switched to the mirror camera image in this case, electronic mirror apparatus 1B can be used effectively.

After the display on display 12 is switched to the mirror camera image in step S204, the flowchart transfers to step S202. In other words, the mirror camera image is displayed until rear door HD is closed, and when rear door HD is opened, the flowchart transfers to step S201, and the display is switched to the rear camera image. As illustrated in FIGS. 8A and 8B, since a back seat is projected and a part of the rear viewing field of vehicle V is cut off in the mirror camera image, the rear camera image is more suitable for rear confirmation. Note that the display processing illustrated in FIG. 7 is finished in response to starting of vehicle V.

Thus, electronic mirror apparatus 1B includes: display 12 for displaying an image from rear camera 21 (first on-vehicle camera) that is installed in rear door HD (hatch) of vehicle V and images a rear viewing field of vehicle V; opened or closed state determination unit 11A for determining an opened or closed state of rear door HD; and display controller 11B for controlling displaying and non-displaying of a rear camera image (a first image) on display 12. When opened or closed state determination unit 11A determines that rear door HD is closed, display controller 11B causes display 12 to display a rear camera image. On the other hand, when opened or closed state determination unit 11A determines that rear door HD is opened, display controller 11B makes non-display of the rear camera image.

Specifically, display 12 in electronic mirror apparatus 1B is configured such that an image from mirror camera 14 (second on-vehicle camera) different from rear camera 21 (first on-vehicle camera) can be displayed. Mirror camera 14 is installed in a part other than rear door HD (hatch). When opened or closed state determination unit 11A determines that rear door HD is closed, display controller 11B causes display 12 to display the rear camera image (first image). On the other hand, when opened or closed state determination unit 11A determines that rear door HD is opened, display controller 11B causes display 12 to display the mirror camera image (second image).

According to electronic mirror apparatus 1B, it is possible to prevent information meaningless to an occupant (for example, a rear camera image on which sky is projected) from being presented and is possible to present useful information to the occupant (herein, the mirror camera image).

Although the invention made by the present inventor has been specifically described above based on the exemplary embodiments, the present invention is not limited to the above exemplary embodiments, but can be modified without departing from the gist of the present invention.

For example, in the second exemplary embodiment, a side camera mounted to a mounting position of a door mirror may be applied in place of mirror camera 14. Also, for example, when rear door HD is opened, other useful information (for example, a digital versatile disc (DVD) video image) may be displayed instead of captured images of surroundings of vehicle V.

In the first and second exemplary embodiments, opened or closed state determination unit 11A may determine the opened or closed state of rear door HD by analyzing the image captured by rear camera 21.

Note that the electronic mirror apparatuses according to the first and second exemplary embodiments are applicable to both cases where vehicle V runs and stops. Since a possibility that the hatch is opened or closed is high during stopping of vehicle V, the electronic mirror apparatuses are particularly useful.

It should be construed that the exemplary embodiments disclosed herein are illustrative in all aspects, and are not restrictive. The scope of the present invention is represented by the scope of the claims and not by the above description, and it is intended that all modifications within the sense and scope equivalent to the claims are involved in the scope of the present invention.

### INDUSTRIAL APPLICABILITY

The present invention is suitable for an electronic mirror apparatus that displays an image captured by a rear camera installed on a hatch.

### REFERENCE MARKS IN THE DRAWINGS

1A, 1B: electronic mirror apparatus
11: controller
11A: opened or closed state determination unit
11B: display controller
111: CPU
112: ROM
113: RAM
12: display
13: one-way mirror
14: mirror camera (second on-vehicle camera)
21: rear camera (first on-vehicle camera)
22: opening or closing detector
HD: rear door (hatch)
V: vehicle

1. A rearview mirror assembly comprising:
a display for displaying a first image from a first on-vehicle camera, the first on-vehicle camera being installed on a hatch of a vehicle and imaging a rear viewing field of the vehicle;
an opened or closed state determination unit for determining whether the hatch is opened or closed; and
a display controller for controlling displaying and non-displaying of the first image on the display,
wherein when the opened or closed state determination unit determines that the hatch is closed, the display controller causes the display to display the first image, and when the opened or closed state determination unit determines that the hatch is opened, the display controller causes the display not to display the first image.

2. The rearview mirror assembly according to claim 1, further comprising a one-way mirror disposed in front of a display surface of the display, wherein
when the opened or closed state determination unit determines that the hatch is closed, the first image on the display is to be visually recognized, and
when the opened or closed state determination unit determines that the hatch is opened, a mirror image on the one-way mirror is to be visually recognized.

3. The rearview mirror assembly according to claim 1, wherein
the display is further configured to display a second image from a second on-vehicle camera different from the first on-vehicle camera,
the second on-vehicle camera is installed at a part other than the hatch, and
when the opened or closed state determination unit determines that the hatch is closed, the display controller causes the display to display the first image, and when the opened or closed state determination unit determines that the hatch is opened, the display controller causes the display to display the second image.

4. The rearview mirror assembly according to claim 3, wherein the second on-vehicle camera is installed near the display and images the rear viewing field of the vehicle.

5. The rearview mirror assembly according to claim 1, wherein the opened or closed state determination unit determines whether the hatch is opened or closed based on a lock signal indicating a locked state of the hatch.

6. The rearview mirror assembly according to claim 1, wherein the opened or closed state determination unit determines whether the hatch is opened or closed based on a detection signal of an acceleration sensor mounted on the hatch.
